(19) United States
(12) Patent Application Publication
(10) Pub. No.: US 2016/0371620 A1
(43) Pub. Date: Dec. 22, 2016

(54) COMPUTERIZED METHOD AND SYSTEM FOR SCHEDULING TASKS FOR AN IN-HOME CAREGIVER

(71) Applicant: Humana Inc., (US)

(72) Inventors: Robert Nascenzi, Louisville, KY (US); Shannon O'Brien, Louisville, KY (US); Ray Sun, Louisville, KY (US)

(73) Assignee: HUMANA INC., Louisville, KY (US)

(21) Appl. No.: 13/831,567

(22) Filed: Mar. 14, 2013

(51) Int. Cl. G06Q 50/00; G06Q 50/22

(52) U.S. Cl. CPC G06Q 10/06314; G06Q 50/22

(57) ABSTRACT

The present disclosure is directed to an in-home care application and system that facilitates continuous health and wellness monitoring, in-home care, and family remote monitoring for seniors, disabled adults, and other clients in need of assistance. Through the use of a computerized device such as a tablet computer, in-home care providers can input case management information; monitor movement, pulse, blood pressure, and other biometrics; ensure medication compliance and safety; track meals, mood, and appointments; and provide updated status summaries and comments for family members and care providers to review. Family members may be able to check the health status of their senior or disabled loved-one through a web-based interface. A central portal provides administrative functions such as reporting, trend tracking and reporting, caregiver/client matching, private messaging, timekeeping, and real-time activity feeds.

### CROSS-REFERENCE TO RELATED APPLICATIONS

None.

### BACKGROUND

As of 2011, there were 76 million baby boomers, the first of whom turned 65-years-old on Jan. 1, 2011. In addition, adults are living longer than ever. In fact, adults age 85 and over are the fastest growing segment in the US. The US Bureau of Labor Statistics projects that the number of home health aides and personal care aides will increase by approximately 70% from 2010 to 2020. This dramatic increase illustrates that as the population ages the need for assisted living increases due to the decline in functionality. Moreover, those experiencing such a decline can over-burden healthcare resources if not provided with sufficient levels of care and monitoring. One in five seniors is re-hospitalized within 30 days of discharge. As a result, family, caregivers, and for-hire homecare providers are looking for systems and tools to support their caregiving activities, while at the same time help them prevent hospital client readmission.

Providing in-home care involves a wide host of activities, from providing daily living assistance to medical care. Home care providers often are required to keep track of appointments, clean house, make meals, schedule doctor appointments, and monitor a client's prescription administration and remaining dosages. In-home care providers are also frequently asked to track a client's pain levels, appetite and mood, make sure that the client is safe in their environment, and instruct the client or other care providers regarding the type of care the client requires in order to best maintain their health. Tracking and managing the various aspects of a client's activities and care requirements accurately and efficiently requires that a care provider have some means of recording the various activities and requirements of a client. Current methods require the use of paper logbooks in which caregivers record basic information about a client as well as details about a client's care and the activities of caregivers. A paper logbook may serve to track and record basic client information but does not readily allow the information to be shared with other care providers, doctors, or family members involved in a client's care. Paper logbooks also do not allow interactive scheduling, time keeping, or reporting. There is a need for a computerized application and system directed to caregivers to assist them in providing care and other services to multiple clients.

### SUMMARY

The present disclosure is directed to an application and system that facilitates continuous health and wellness monitoring, in-home care, and family remote monitoring for seniors, disabled adults, and other clients in need of assistance. Through the use of a computerized device such as a tablet computer, homecare providers can input case management information; monitor movement, pulse, blood pressure, and other biometrics; track meals, mood, prescription drugs, and appointments; and provide updated status summaries and comments for family members and care providers to review. Family members may be able to check the health status of their senior or disabled loved-one through a web-based interface. A central portal provides administrative functions such as reporting, trend tracking and reporting, caregiver/client matching, private messaging, and real-time activity feeds. Additionally, such a system may provide a paperless means for the management of care that is easily backed-up or transferred to a hospital or other care facility.

### BRIEF DESCRIPTION OF THE DRAWINGS

FIG. 1 is a schematic diagram of an embodiment of an in-home care system showing a client's home and an application portal;

FIG. 2 is a schematic diagram of an embodiment of servers used in an in-home care system;

FIG. 3 is a screenshot of a calendar interface;

FIGS. 4a-4e are representations of scheduled tasks and events;

FIGS. 5a and 5b are a flow diagram of a scheduling algorithm;

FIG. 6 is a screenshot of a caregiver login interface;

FIG. 7 is a first flow diagram of a home care application according to an example embodiment;

FIG. 8 is a second flow diagram of a home care application according to an example embodiment;

FIG. 9 is a screenshot of a client profile user interface;

FIG. 10 is a screenshot of a contact list user interface;

FIG. 11 is a screenshot of a daily task list user interface;

FIG. 12 is a screenshot of a user interface showing information about a client's dietary needs for a meal;

FIG. 13 is a screenshot of a user interface for reporting a client's meal consumption and appetite level;

FIG. 14 is a screenshot of a medication to-do list user interface illustrating an alert notification;

FIG. 15 is a screenshot of a to-do list user interface with a presentation of morning medications for a single day;

FIG. 16 is a screenshot of a virtual pill case user interface;

FIG. 17 is a screenshot of a virtual pill case displaying detailed drug information;

FIG. 18 is a screenshot of a summary of drugs user interface; and

FIG. 19 is a screen shot of a web-based dashboard user interface.

### DETAILED DESCRIPTION

An in-home care application may be directed to multiple groups of users. A primary user may be a non-technical caregiver who goes to the home of a client to provide care. An in-home care provider, the employer of the caregiver or other care providers may find such an application useful to manage caregivers, track client health and activities, and generate reporting and other useful analytics. Given the non-technical nature of the caregiver, the application is intuitive and easy-to-use. Family members of the client who participate in the care of the client may find an application such as that described allows them to participate in the care of the client and also provides those family members with frequent status reports to help develop a level of confidence and trust that the client is receiving the level of care that is expected. The in-home care provider or family members may find such an application useful to plan the care recipient's activities, schedule appointments, manage grocery lists, track errands, and communicate with other caregivers and family members. Using an in-home care application, a caregiver providing care to a client may interact with such an application in order to schedule care, receive reminders, or view calendars. The caregiver may also use the application to check in when they arrive at a client home and check out when they depart. The application may be used as a tool to track key contact, medications, and other potentially confidential information associated with a client. When implemented on a computing device in a client's home, the computing device may be configured to monitor electronic measuring devices and other equipment such as diagnostic instruments and environmental monitors. The application may be used to enter client health data and track medications and client conditions.

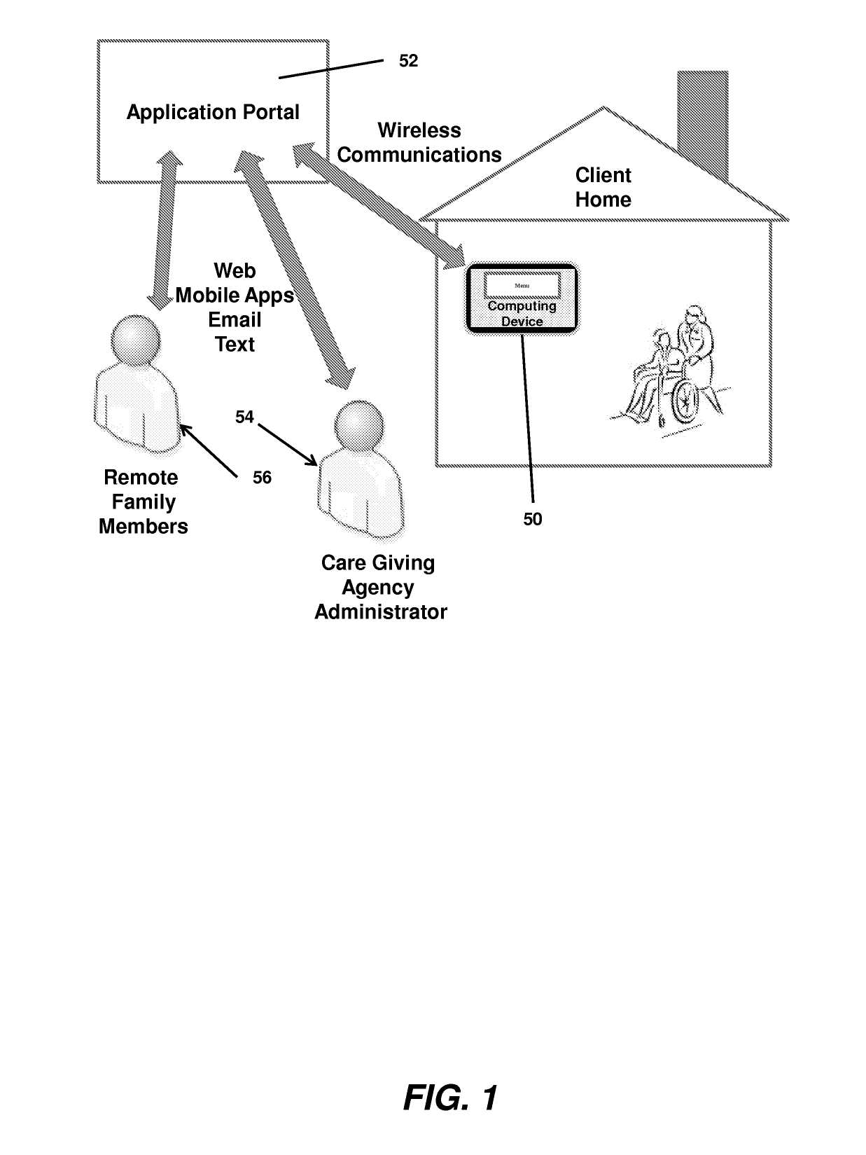

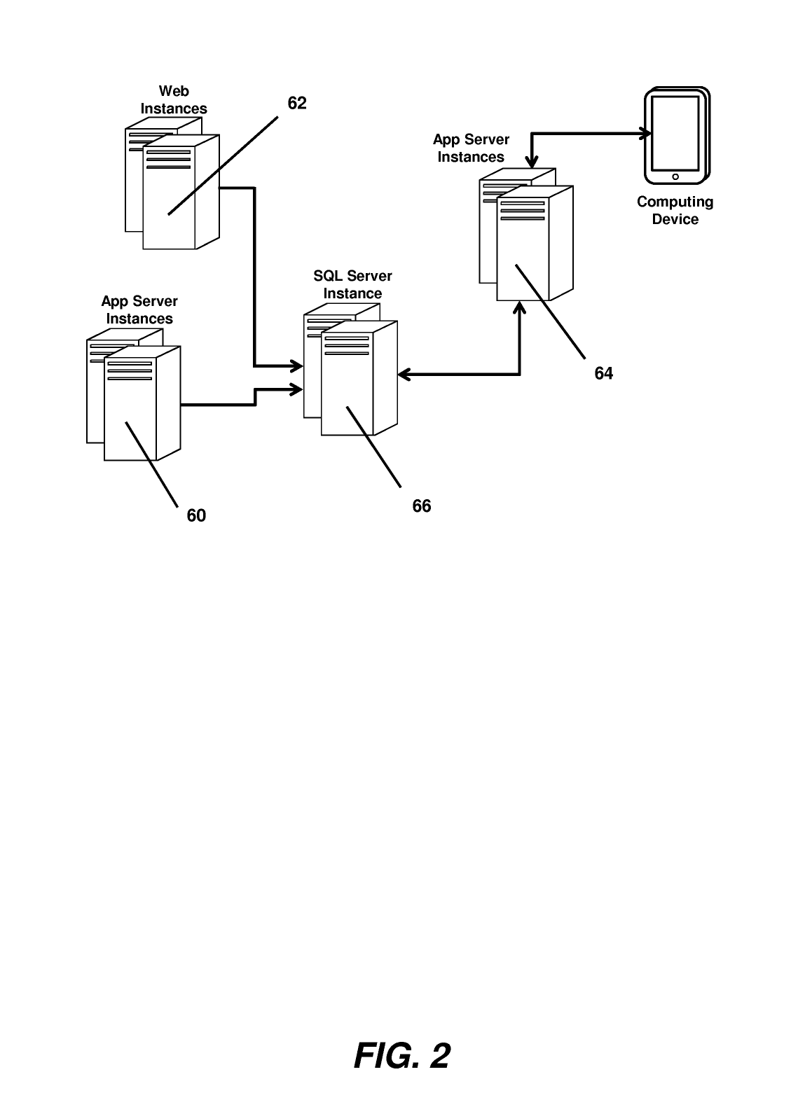

Referring to FIG. 1, an in-home care application may be deployed using a mobile computing device 50 located in a client's home, and an application portal 52 which communicates with the computing device, administrative personnel 54, and family members of the client 56. Such a mobile computing device may be a tablet computer but such an in-home care application may also be implemented on other types of computerized devices such as smart television sets or smart phones. When implemented using a computing device 50 in a client's home, communication between an application portal 52 and the computing device may be performed using wireless technology or alternatively, accomplished by other means which may comprise a wired connection to a network or a method of caching data for later synchronization. Wireless connections may comprise wireless local area networks connected to the Internet or methods using cellular data. The application portal 52 may serve as an interface for administrative personnel and family members. Administrative personnel may access the portal to manage caregivers (e.g., accounts and profiles), generate status reports, receive alerts, or communicate with caregivers, family members, or clients. Family members may access the application portal 52 to view status updates, request additional services or care, or communicate with the client or caregiver. Referring to FIG. 2, the applications portal system may comprise application servers 60, web servers 62, communications servers 64, and database servers 66. These servers may be located in a data center or cloud computing service provider. Communications between the various components of the in-home care application may be performed using secure methods of communicating such as virtual private networks or other encryption methods.

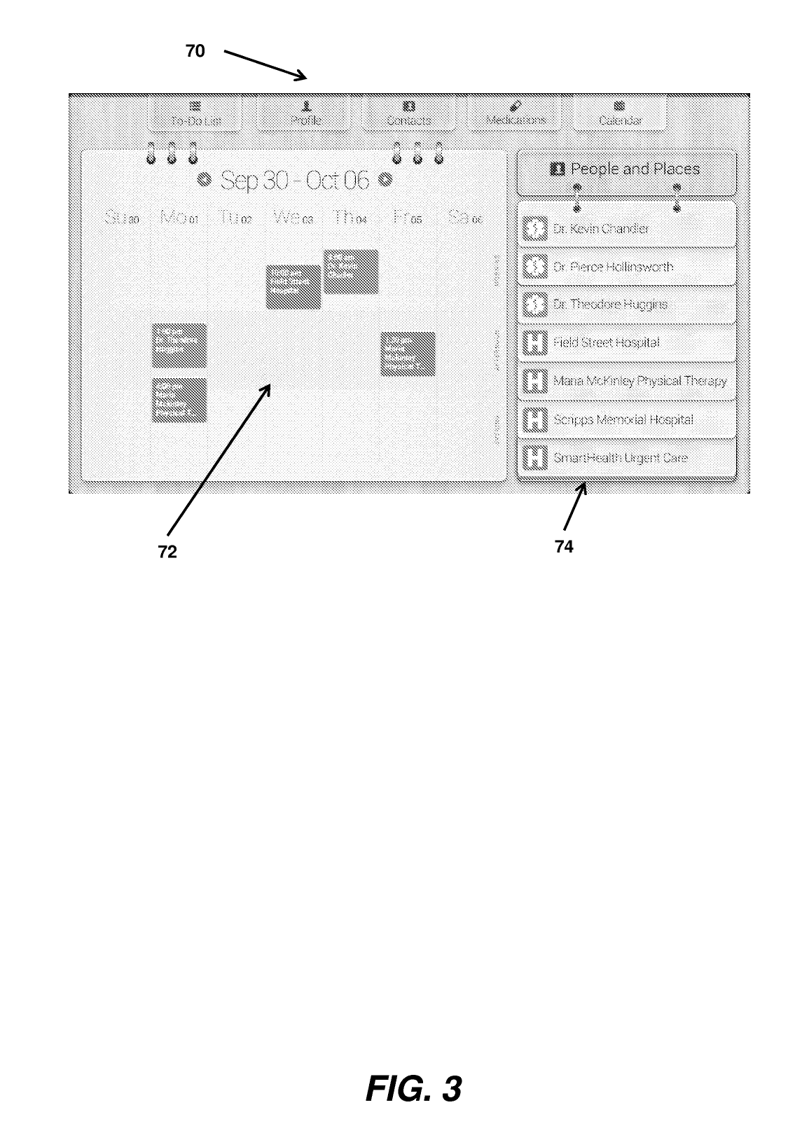

Both the application portal and application display on a computing device may contain a menu to allow a user to select functions of the application used to perform tasks. In FIG. 3, the menu is illustrated as a series of tabs across the top of the displayed image 70. The available menu may be configured to provide only those choices available to a user depending upon the user's function and permission levels. For instance, family members may not be shown options related to medication delivery or caregiver training and reference material. FIG. 3 displays one possible implementation of such a menu. When a user selects a menu choice, the displayed material changes to correspond to the selected menu choice.

Appointment Scheduler, Calendar and Reminders

An in-home care provider may employ multiple caregivers, each with multiple clients. Clients with reduced mobility or other limitations may require assistance with tasks such as cleaning, running errands, meeting repair service providers, or transportation. As a result, each client may have an individual schedule 72 containing appointments, events, and other reminders for a variety of activities. Coordinating these individual schedules may be difficult for a caregiver and even more so for an in-home care provider with multiple clients. The problems of tracking and organizing a client's schedule are solved by an appointment scheduler synchronized with an application portal which provides synchronization with a caregiver's schedule.

An in-home care application may be used as an electronic calendar in order for the client and caregiver to schedule future visits by caregivers providing care and assistance to the client. Referring to FIG. 3, after selecting the calendar function, a user of the application may select people and places 74 and drag them onto the calendar. Alternatively, a user may create a new appointment by selecting a time and date on a calendar and entering information to create the appointment. Once an appointment has been created, a user may edit the appointment to make changes or delete the appointment entirely. Such a calendar may be synchronized with other calendars housed in databases 66 within the application. Such synchronization may allow a caregiver using the computing device 50 or website at the application portal to organize and track client activities such as appointments with physicians, deliveries, birthdays, chores, and other routine activities. A caregiver may use such a calendar to improve the care and assistance provided to the client by coordinating the caregiver's schedule to allow for follow-up after appointments, assist the client in the arrangement of transportation, and make sure that the client has assistance with deliveries if needed.

An in-home care provider may analyze multiple tasks and appointments in order to allocate their time and resources efficiently. When a caregiver enters calendar information or a task for a client, the in-home care application receives this request and processes it to arrive at an optimal schedule. The application may suggest alternate times and dates for various tasks or activities so that a caregiver may schedule his or her time such that tasks or errands may be grouped together by time and location. As an example, if a client is scheduled for a medical appointment and also has added a visit to a department store onto an errand list, this appointment and errand may be grouped together on a client calendar such that the caregiver makes only one trip. During this same time a task may have been originally scheduled, but may be automatically rescheduled on the daily to-do list or moved to a more convenient day. In this way, an in-home care application may process multiple tasks and appointments such that the total care provider resources available to an in-home care provider are efficiently allocated.

In order to assign and manage tasks as they are entered by caregivers, in-home care providers, family members, clients, or other users of the application, such tasks may be sorted and grouped by the application into date ranges as the tasks are entered. When the algorithm is implemented on a tablet computer, to-do list items are grouped into one-day ranges and calendar tasks are grouped into one-week ranges. Tasks may comprise: medication refill reminders, medication administration tasks, daily routine tasks, and miscellaneous tasks. Tasks that are not completed during a date range may be moved by the application to the next date range. An exception to this action is recurring tasks that may occur in the next range even if completed during the first range. In such a case, a missed task is not moved to the next range because an occurrence of the task may already exist in the second range. As an example, if the date range is one day in duration and a recurring task normally occurs once per day, missing the task on a first day does not cause the task to appear twice on a second day.

Daily routine tasks may comprise wakeup, breakfast, lunch, dinner and bedtime tasks. Daily medication administration tasks may be assigned to a particular time of day or occurrence. “Take as needed” medications are not scheduled in the application due to their as-needed nature. Other task items that may be assigned to a to-do list or calendar may comprise tasks such as appointments, chores, errands, and activities to be completed.

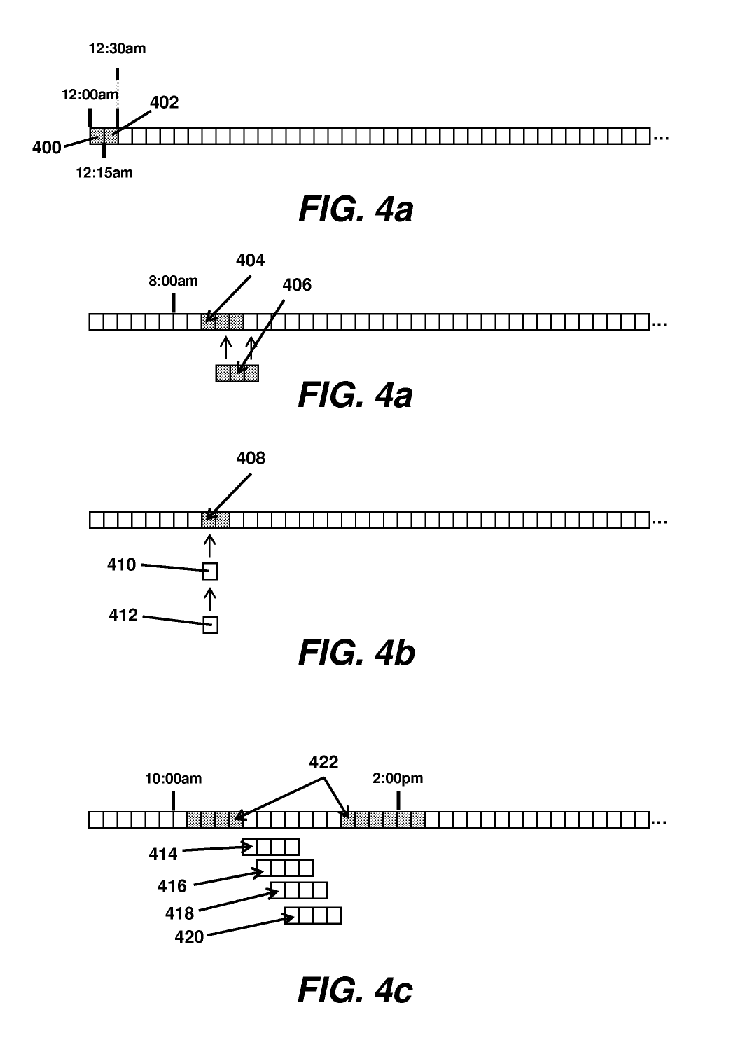

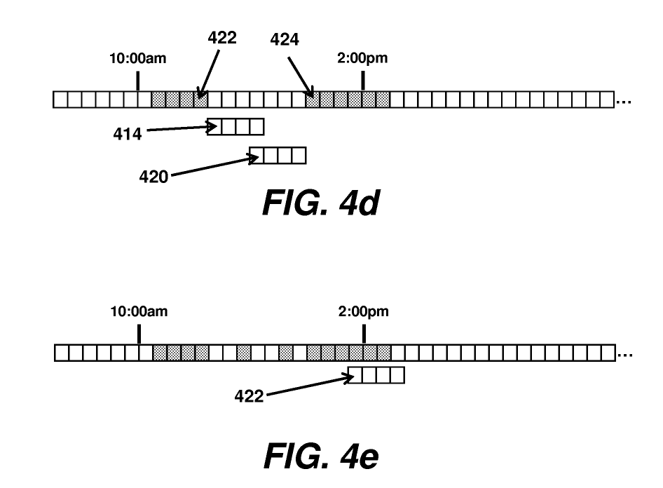

Date ranges may be further divided into 15 minute increments. These increments, or “slots,” may span the entire date range and be used as place-holders for tasks. Referring to FIG. 4a, the beginning of a day is represented by a series of slots starting at 12:00 am. The first slot 400 encompasses the time from 12:00-12:14 am, the second slot 402, from 12:15-12:30 am and so-on until the period is completely divided into slots.

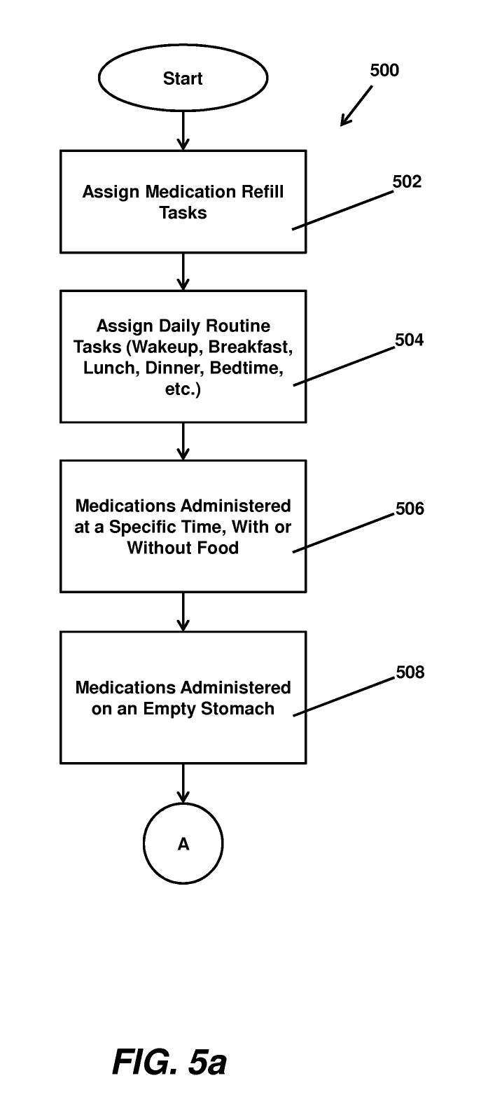

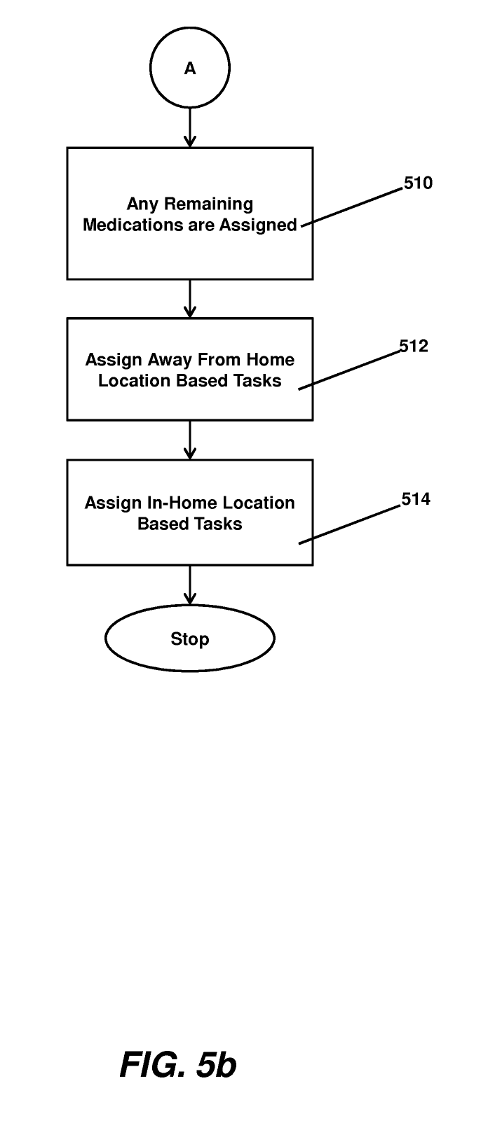

The duration of a task determines the number of slots that a task occupies once assigned. Daily routine tasks default to a duration of thirty minutes. To insure that certain more critical tasks are completed in a timely fashion, tasks are assigned in a priority order. FIGS. 5a and 5b illustrates a flow diagram of the priority assignment process 500. In step 502, medication refill reminders are inserted at the beginning of each day with a duration of zero. Tasks that occur at a specific time during a period are assigned in step 504. Examples of such time-specific tasks include daily routine tasks such as wakeup, breakfast, etc. Time-specific tasks are not rearranged to accommodate overlapping occurrences. Referring to FIG. 4b, a first time specific task with a duration of 45 minutes and starting time of 8:30 am 404, may not cause a second time-specific task with a starting time of 8:45 am 406 to be reassigned. Next, as shown in Step 506 of FIG. 5a, medications that require food, are required to occur in a specific period of time, or both, are assigned. As illustrated in FIG. 4b, breakfast may be scheduled at 408. Morning medications that require food 410 and morning medications that do not require food 412 are assigned as zero duration tasks in the same time slots as breakfast. In step 508 of FIG. 5a, medications that require an empty stomach are assigned one hour before a meal. Another possible assignment for empty stomach medications may be one hour after a meal. As shown in FIG. 5a at step 510, any remaining medication tasks are assigned and may be distributed throughout the date range.

Referring to FIG. 5b at step 512, location-based tasks that are away from the home are assigned next. These location-based tasks are further ordered by appointment, chores, activities, and errands. Such tasks are assigned to time-of-day ranges that correspond to: morning (6 am-10 am), afternoon (10 am-4 pm), evening (4 pm-10 pm), bedtime (the two hours before bedtime), and anytime tasks that may be scheduled from 6 am-10 pm. The in-home care application task scheduler may search for unassigned slots within a time-of-day range. Referring to FIG. 4c, in an exemplary embodiment where an away-from-home task requires one hour, the algorithm creates a list of all unassigned slots 414, 416, 418 and 420 that can accommodate the one hour duration of the task. The algorithm checks the list of slots to determine if there are away-from-home tasks assigned to slots adjacent to the slots listed 422. If there are no away-from-home tasks assigned adjacent to the available slots, the task is assigned to the first available group of slots which is able accommodate the duration of the task 414. Referring to FIG. 4d, if there are away-from-home tasks assigned to adjacent slots before the available slots 422, the task is assigned starting in the slots immediately following the adjacent away-from-home task 414. If there are away-from-home tasks assigned after the available slots 424, the task is assigned to the required number of slots immediately before the adjacent away-from-home task 420. Referring to FIG. 4e, if the algorithm does not identify any unassigned slots large enough to accommodate the task, it is assigned to slots 422 at the end of the time-of-day period (morning, afternoon, evening, etc.) even if there are tasks already assigned to those slots.

To ensure efficiency, GPS and mapping services may be employed to group out-of-home tasks such as visiting a pharmacy or going to a dentist appointment. When grouping out-of-home tasks, the application scheduler may consider the distance between or the proximity of the task locations to avoid grouping out-of-home tasks that may require extensive travel such as travel from one end of the client's city to another. Additional factors such as time of day and traffic concerns may also be used to group away from home tasks. Various distance measures, tolerances, or proximities may be specified for use in grouping tasks in a manner that is convenient and comfortable for the client as well as the caregiver.

Referring to FIG. 5B at step 514, tasks that may take place in the home are assigned next. In a manner similar to away-from-home tasks, these in-home tasks are further ordered by appointment, chores, and activities. In-home tasks are assigned to time-of-day ranges that correspond to: morning (6 am-10 am), afternoon (10 am-4 pm), evening (4 pm-10 pm), bedtime (the two hours before bedtime), and anytime tasks that may be scheduled from 6 am-10 pm. The in-home care application task scheduler may search for unassigned slots within a time-of-day range and assign tasks in the same manner as the away-from-home tasks except that in this instance, when looking for adjacent tasks, the algorithm looks for adjacent in-home tasks instead of away-from-home tasks. In the same manner as away-from-home tasks, tasks for which there are no available unassigned slots are assigned to the end of the time-of-day period. In order to present a clear, easy to interpret display, tasks may be grouped together for display. The user interface may display a single item for a certain time of day or time of week slot. When a user selects such an item, the item may expand within the user interface to display the grouped-together tasks. Items are displayed as a chronological list. When an item is expanded in the user interface, the tasks grouped within the item appear in the order in which they were inserted into the slot or slots represented by the item. In an example embodiment, the following rules may be used in grouping tasks.

TABLE 1
Example Task Grouping Rules

| | |
|---|---|
| Medications | Group meals and medications that require food or for |
| Food | which it does not matter. |
| Requirements | |
| Medication | Group medications that are administered at the same |
| Time | time of day: |

| | |
|---|---|
| Requirements | Morning Medications |
| | Afternoon Medications |
| | Evening Medications |
| | Bedtime Medications |

| | |
|---|---|
| Other Tasks | Appointments, chores, errands, bedtime, wakeup are |
| | stand-alone and are not grouped with any other tasks. |

In an example embodiment, application of task grouping rules may result in the grouping of tasks as shown in Table 2.

TABLE 2
Example Task Groupings

| | |
|---|---|
| Task 1 | Wakeup |
| Task 2 | Breakfast with Medications |

Breakfast
Medication 1
Medication 2

| | |
|---|---|
| Task 3 | Appointment 1 |
| Task 4 | Appointment 2 |
| Task 5 | Chore 1 |
| Task 6 | Lunch |
| Task 7 | Chore 2 |
| Task 8 | Chore 3 |
| Task 9 | Errand 1 |
| Task 10 | Dinner |
| Task 11 | Chore 4 |

Caregiver characteristics may also be considered when an algorithm prioritizes and assigns tasks. Such characteristics may comprise factors such as a caregiver not having convenient transportation for away-from-home tasks, a caregiver's inability to perform complex or physically demanding tasks, or a caregiver's allergies when a task may present an allergic risk when performed.

The computing device 50 may store such a calendar in its internal memory and report the information contained in the calendar to an application portal. The application portal may report information back to the computing device 50 so that the computing device may display information such as availability of other caregivers and family members. Such information may be used by the caregiver or family member to make adjustments to the client's scheduled activities which may be dependent upon the availability of other resources as communicated from the application portal. In this way, family members, caregivers, and in-home care providers may optimize their own schedules to save time and maximize the utilization of resources.

An in-home care application calendar may be further provided with the ability to generate alerts and reminders for the client and caregiver, and also delivery of such alerts to a family members so that the family members may follow-up with the caregiver to make sure that the caregiver is aware of an alert or a reminder and provide assistance as needed with regard to the task or follow-up action indicated by the alert or reminder. Alerts to the caregiver may be communicated from the computing device 50 while alerts to the caregiving agency or family member may be delivered through a variety of channels which may comprise the computing device 50, web pages, email, text messages, and mobile applications running on smart phones or tablet computer devices.

Caregiver Check-In

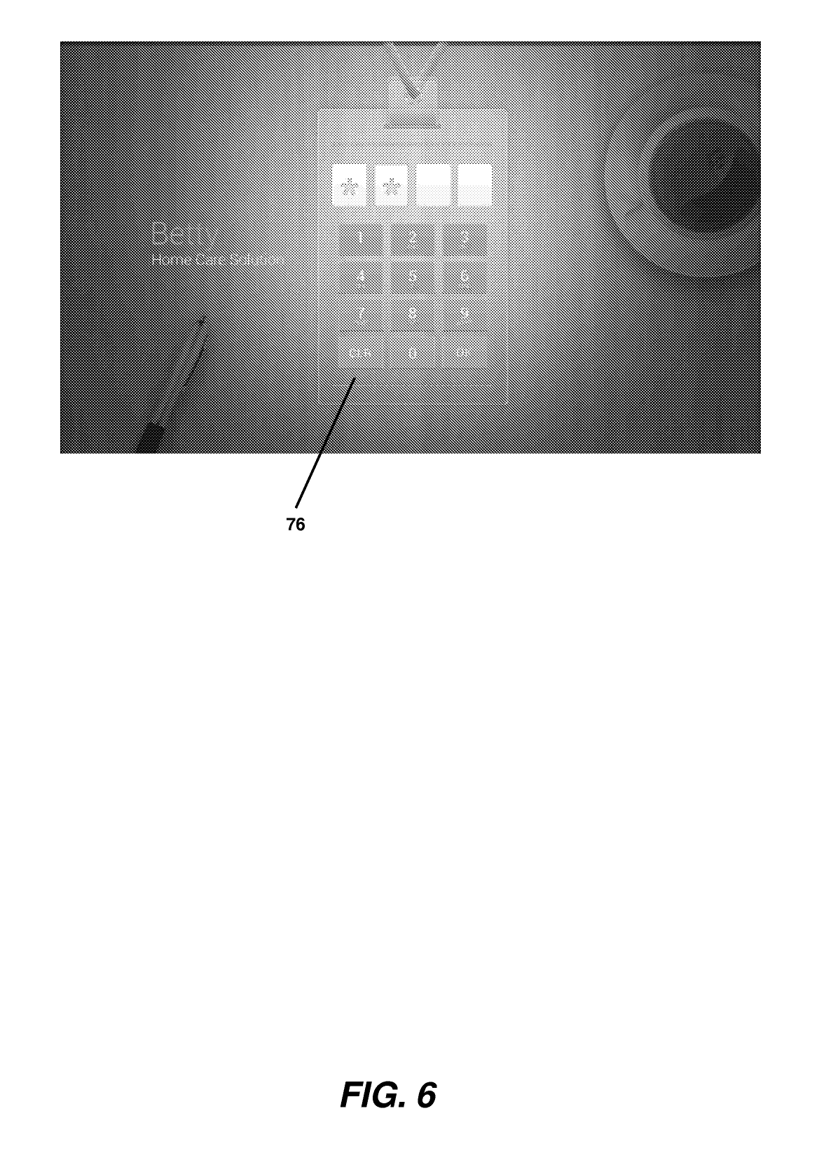

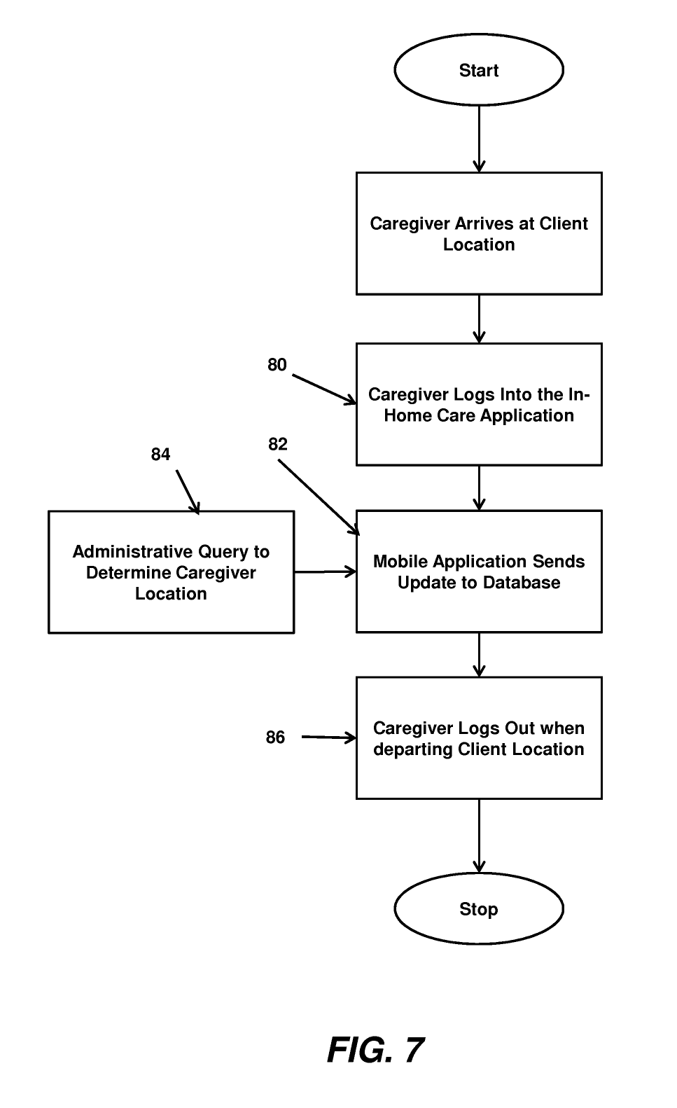

The problem of accurate timekeeping by the caregiver employer is solved by a check-in/check-out system that communicates the data to an application portal which consolidates that data and makes summary data available to the caregiver employer and family members. A caregiver or other service provider may check-in to the in-home care application using facial recognition and location services to confirm the identity of the service provider, thus limiting fraud. Alternatively, a caregiver may check in using a username and password. FIG. 6 illustrates a possible embodiment of such a username and password-based caregiver check in system. After a caregiver enters his or her username, a password entry keypad 76 is displayed on a user interface. Such a check in system may also be used to secure the in home care application in order to prevent unauthorized access to client information. An in-home care service provider may utilize the check-in/check-out system to track the time spent with a client related to daily tasks in order to offer additional services to respond to changing circumstances or additional client requests. FIG. 7 illustrates the caregiver check-in and check-out process. In step 80, a caregiver checks into the application at a client's location. Shown in step 82 is the application updating the caregiver's status in the application database. As shown in step 84, an administrator at the in-home care provider may query the application to determine where a caregiver is located. Step 86 shows the caregiver checking out when leaving a client's location.

Payroll

The related problem of tracking the working time of caregivers for payroll purposes is solved by a timekeeping system integrated into the in-home care application. In-home care providers may have a large number of employees or contractors that provide in-home services to clients. Managing such a large number of employees or contractors may present problems for the providers because the in-home nature of the services performed requires employees to travel from client to client. While most such employees or contractors are diligent in their performance of such services and tracking their time, the nature of the services may allow an employee to abuse the non-supervised nature of their work environment. A timekeeping system that is integrated into an in-home care application may transmit recorded arrival and departure times to a central location which may then consolidate time entries from client locations to which a caregiver may be providing service. The caregiver may enter arrival and departure times into a device which remains in the home of the client. Because of this feature, the caregiver may not be able to enter time when that caregiver is not actually at a client location. This timekeeping function may be integrated into the check-in/check-out function described above. The data from the in-home device may be transmitted to the in-home care provider via the application portal 52 and consolidated into time reports which may audited if desired to ensure that caregivers are providing the number hours of services expected. Additional information regarding the type of services performed and their duration may be entered into such a timekeeping system. This information may be used to generate documents for billing purposes.

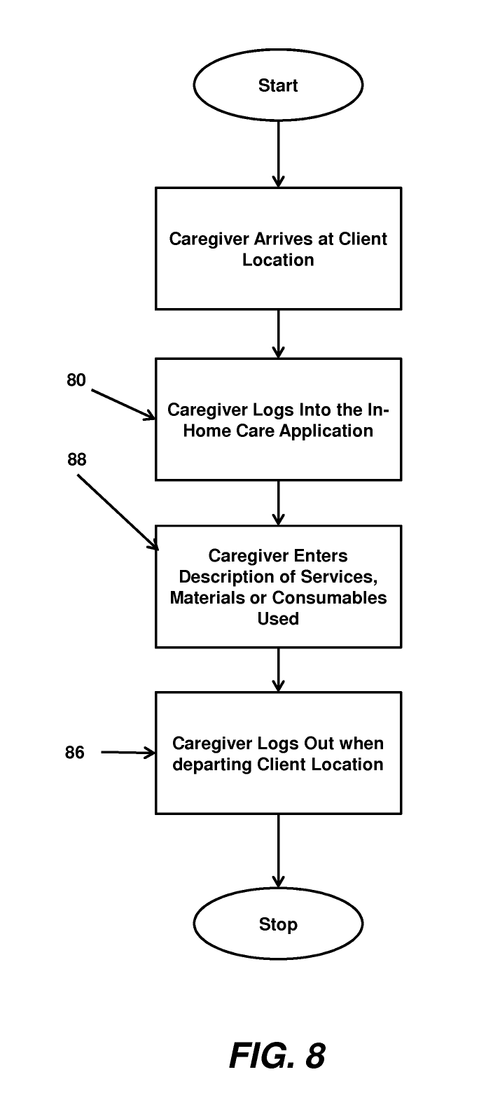

Referring to FIG. 8, when a caregiver arrives at a client home, that caregiver may log their arrival 80 using the in-home care application. When the caregiver has performed the services to be delivered to the client, that caregiver may then log their departure 86 using the application. If desired, additional information may be entered into the application. The additional information 88 may comprise services provided, detailed notes about the condition of the client, time spent performing activities that may be billed at different service rates, or materials or consumables used by the caregiver. An application of speech-to-text technology for spoken summaries of daily activity by caregivers into the mobile computing device may be displayed as text in the live feed to the application portal. Arrival, departure and any additional information may be transmitted 82 to an application portal where it may be retained and used for payroll, billing, care review, and regulatory compliance.

Profile

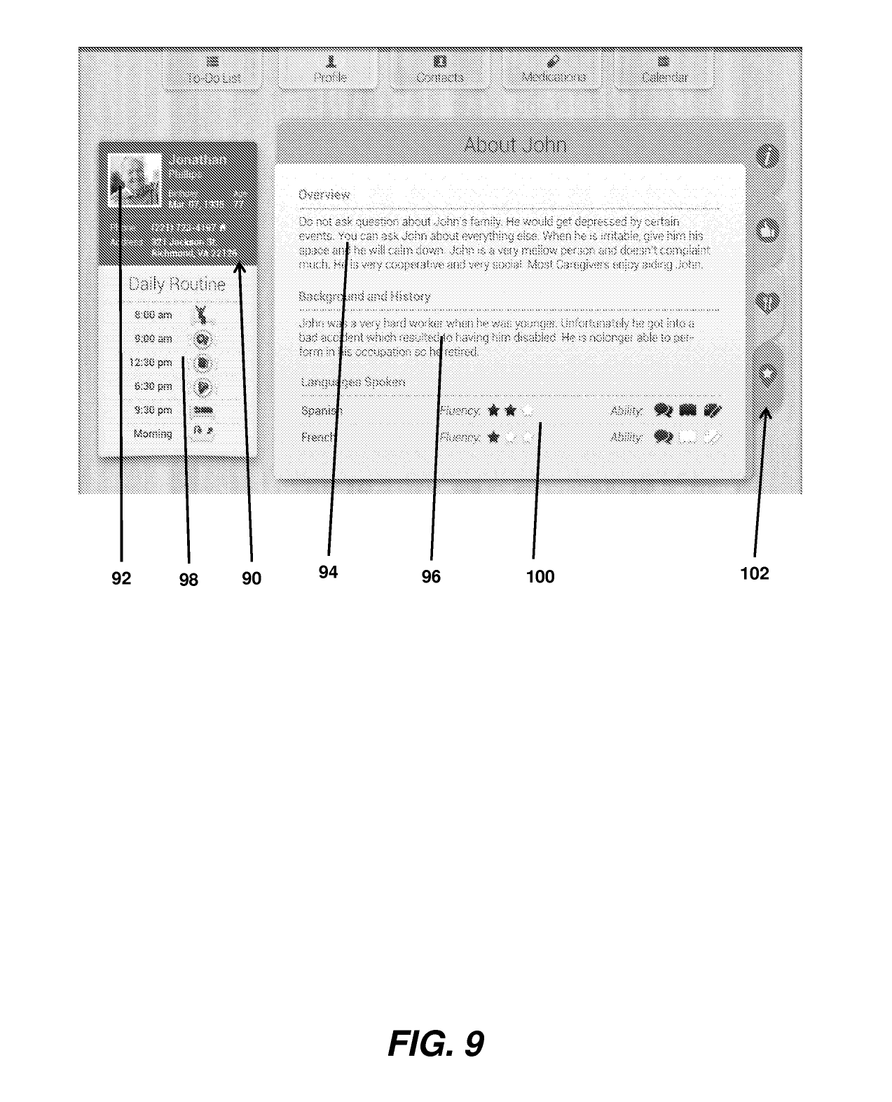

In addition to care requirements, personal profile information about the client may be made available to users of the in-home care application through a profile function. Such profile information may assist a caregiver in understanding a client and avoiding situations that may upset a client. A user of an in-home care application may select a client profile to view such information. Referring to FIG. 9, an example embodiment of an in-home care application profile is shown. The profile information comprises general information 90 such as a client's name, age, birth date, address and phone number. The profile information may include a photograph 92 of the client to allow for positive identification of the client in situations in which a caregiver unfamiliar with the patient is providing services. An overview section 94 may contain a general description of the client's personality, conversational topics of interest to a client, or conversely, topics which should be avoided. Additional information such as a background and history section 96, a client's daily routine 98, and languages spoken by a client 100 may be provided in a profile function implemented in an in-home care application. Additional profile topics may be included in the profile as illustrated by selectable tabs 102.

Key Contact List

Caregivers may find themselves in situations in which they wish to contact a client's family members, physicians, nurses, pharmacies, or other important contacts. Often these contacts are contained in address books, receipts, or other non-centralized locations. A caregiver may have to search through a number of storage locations in order to find a contact, resulting in delay and unproductive use of the caregiver's time. The problem of multiple storage locations for such information is solved by a contact list which may be maintained by an in-home care application and stored in a database maintained in an application portal. A contact may be entered into the in-home care application by completing a contact template. Once entered, the contact is stored in a database, and made available for retrieval using a search function. In addition to telephone, email, and address information, relationship to a client, an indication that a contact is a key contact, information such as whether a contact is listed as having power of attorney, and other comments and notes may be stored for a contact.

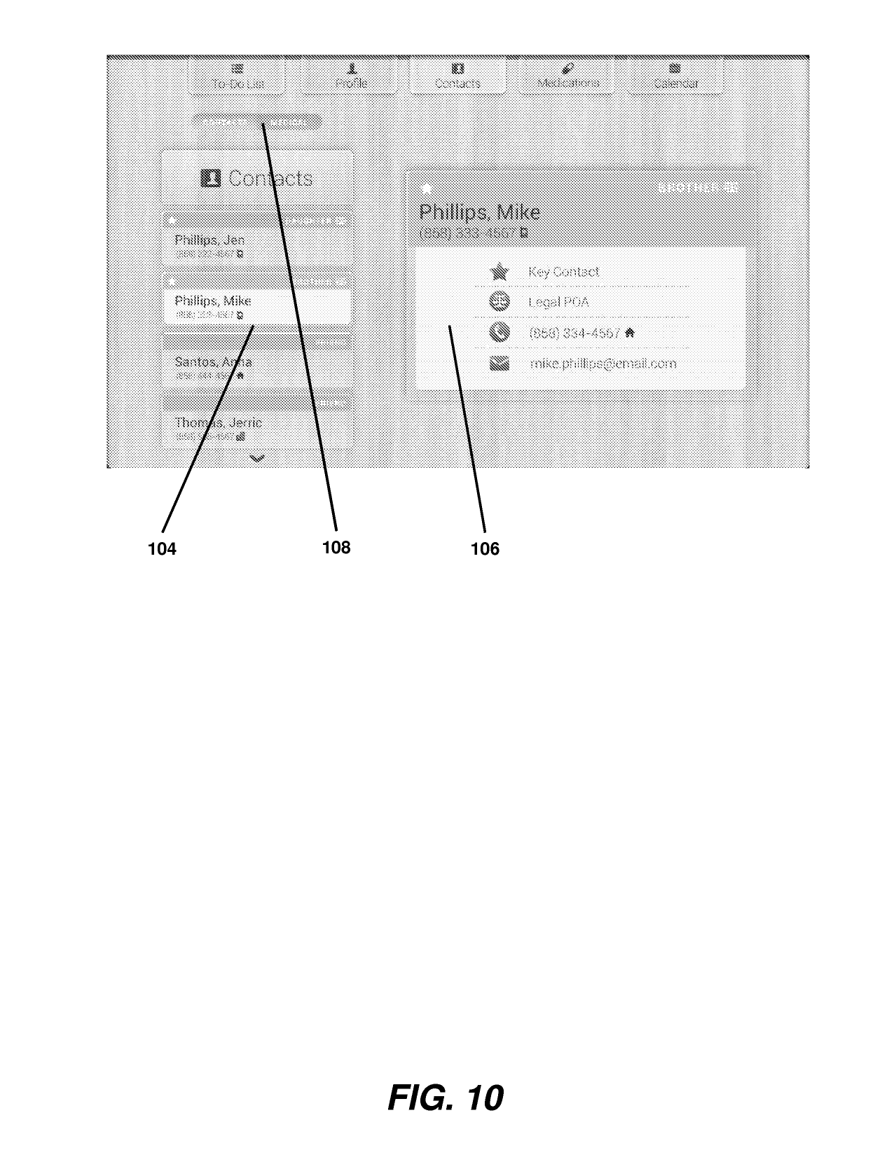

Contact information stored using the in-home care application may be made available to caregivers, family members, and the client through a computing device or the application portal. Family members who have a need to contact the client's pharmacy may obtain the contact information for that pharmacy from the in-home care application's database by logging into the in-home care application's application portal. In another example, a care provider may be able to search a client's contacts for a medical care provider such as a dentist and schedule appointments on behalf of the client. Because contact information is stored in a database which is accessible to an application portal, the in-home care provider may also manage contacts on behalf of a client. An exemplary implementation might be one in which the in-home care provider manages a list of approved care providers comprised of providers such as pharmacies or dentists to assist the client such that it becomes easier to comply with insurance company or other requirements. A possible embodiment of a contact list is shown in FIG. 10. A list of contacts 104 may be displayed with summary of each contact. A contact may be selected from the group in order to display more detail as illustrated by a contact “card” 106. Such a card may contain additional information about the contact comprising such information as email addresses, phone numbers, indications of power of attorney status, relationship to client and key contact status. In order to facilitate quick access to medical care for a client, a control 108 may be implemented in the user interface that limits the displayed contacts to those related to client medical care.

Errand Tracking

The problem of managing everyday tasks for which a client needs assistance is solved by an errand tracking application. Such an application may allow a care client to enter requested services into the application such that a client may tailor such assistance tasks to their everyday needs. When entered, these tasks may be processed by the application and assigned by the in-home care provider to various caregivers. Errands and tasks may be processed by the in-home care application such that tasks are grouped and scheduled in the most efficient manner. The in-home care application may group tasks by task type and location such that a caregiver may be assigned a group of similar tasks or task that may be accomplished in one location.

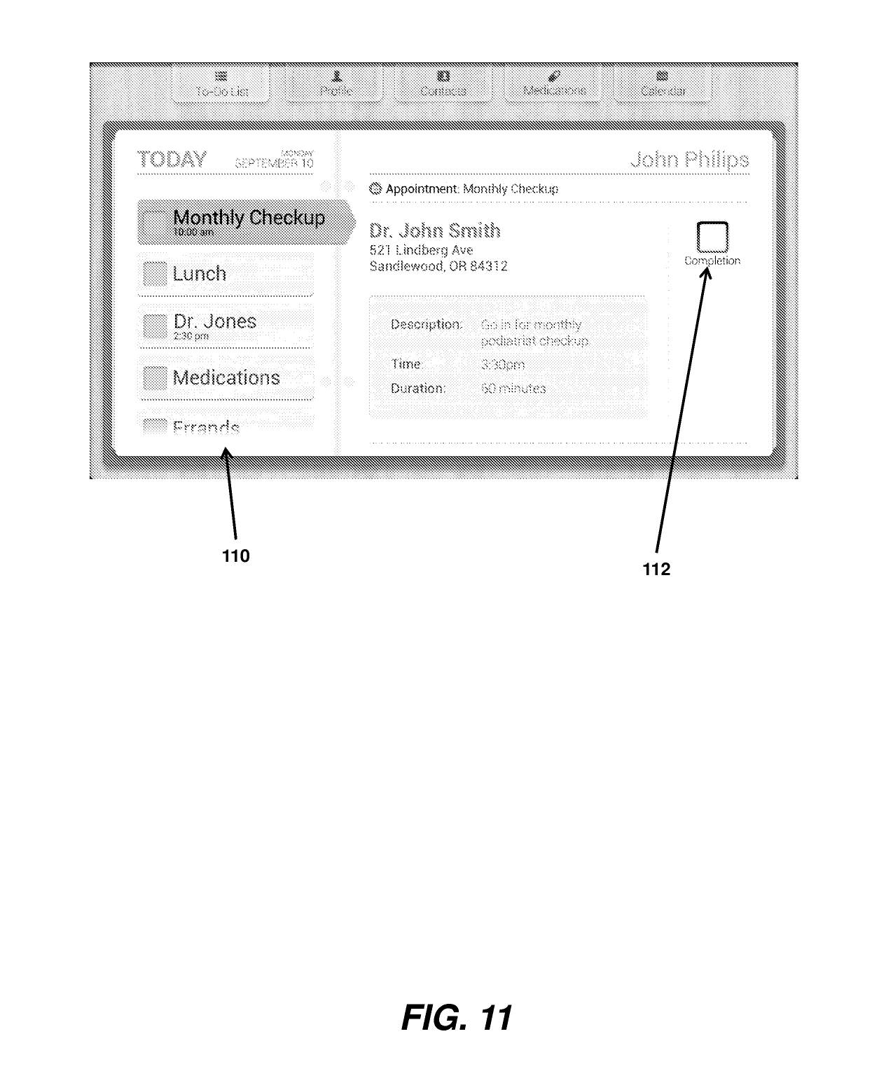

As illustrated in FIG. 11, errands may be displayed in a to-do list 110 or calendar display. Errands and tasks may be displayed with a completion check box 112 which a caregiver may mark as done when the errand has been completed. When a caregiver completes an assigned errand or task, that caregiver may mark the task done in the application. In this way, the client, the in-home care provider, and a client's family may track the completion of the requested tasks. Incomplete tasks may be displayed in a summary screen or converted to alerts when a preset time has elapsed without an errand or task being marked as complete. The in-home care application may also allow the client or client's family to enter comments to each task to provide additional information or feedback on the completed task.

Encrypted Lock Box

The problem of having quick access to important information such as insurance carrier information, living wills, bank account information, power of attorney, locations of important documents, and other critical information is solved by an encrypted storage location maintained in the in-home care application. A client or family member may enter or scan such critical information into this storage location where the information is encrypted and securely stored. Such information may be communicated to the in-home care application server where it is backed up on a database and made available in an application portal to those parties who the client authorizes. In the event of an emergency, an authorized party may log into the storage location for quick access to such information. Access from a family access portal may be provided to allow family members to access the information without the need to travel to a client's location.

Collaboration Portal

The problem of communication between family members, care providers, and other appropriate parties is solved by a collaboration portal which may be integrated with other in-home care application functions. For example, a group of family members may wish to discuss amongst themselves and with the caregiver, in a secure environment, an aspect of the client's care. In another example, a family member may post a photo and ask the caregiver to show it to the client. A communications portal such as this may be accessed from a mobile computing device located in a client's home or may be accessed from a collaboration portal which may be located on an internet website.

Meal Planning and Tracking

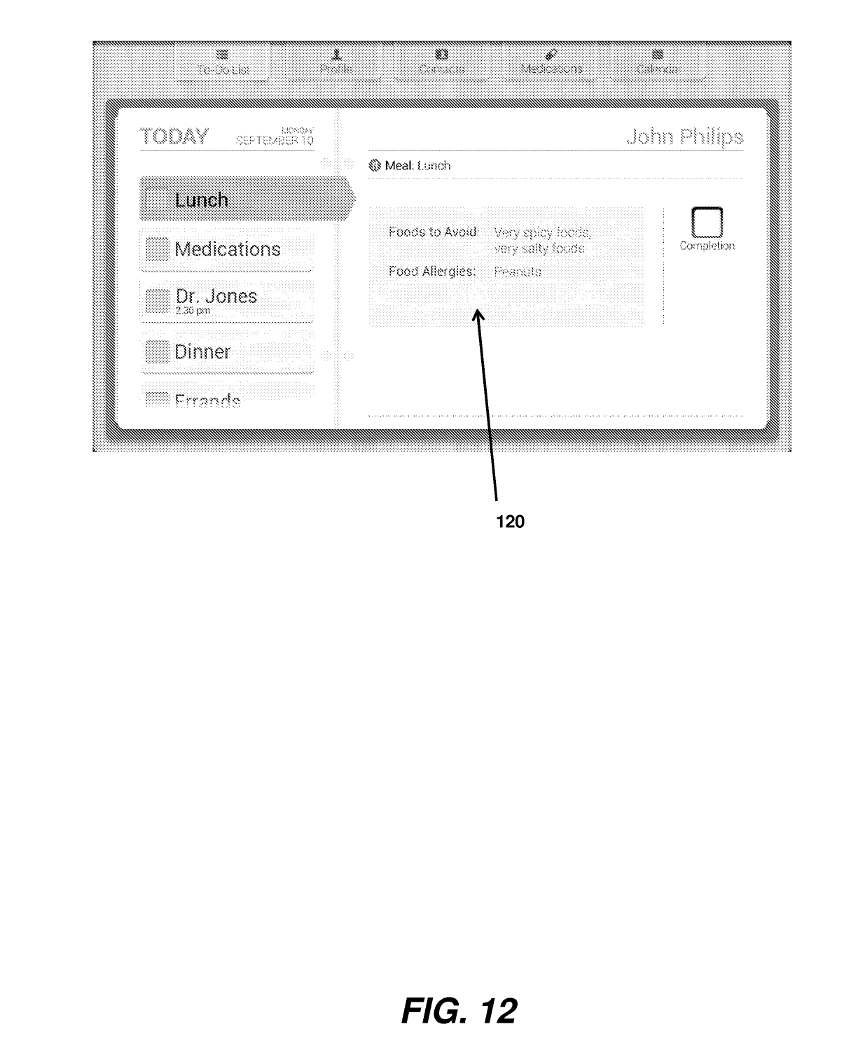

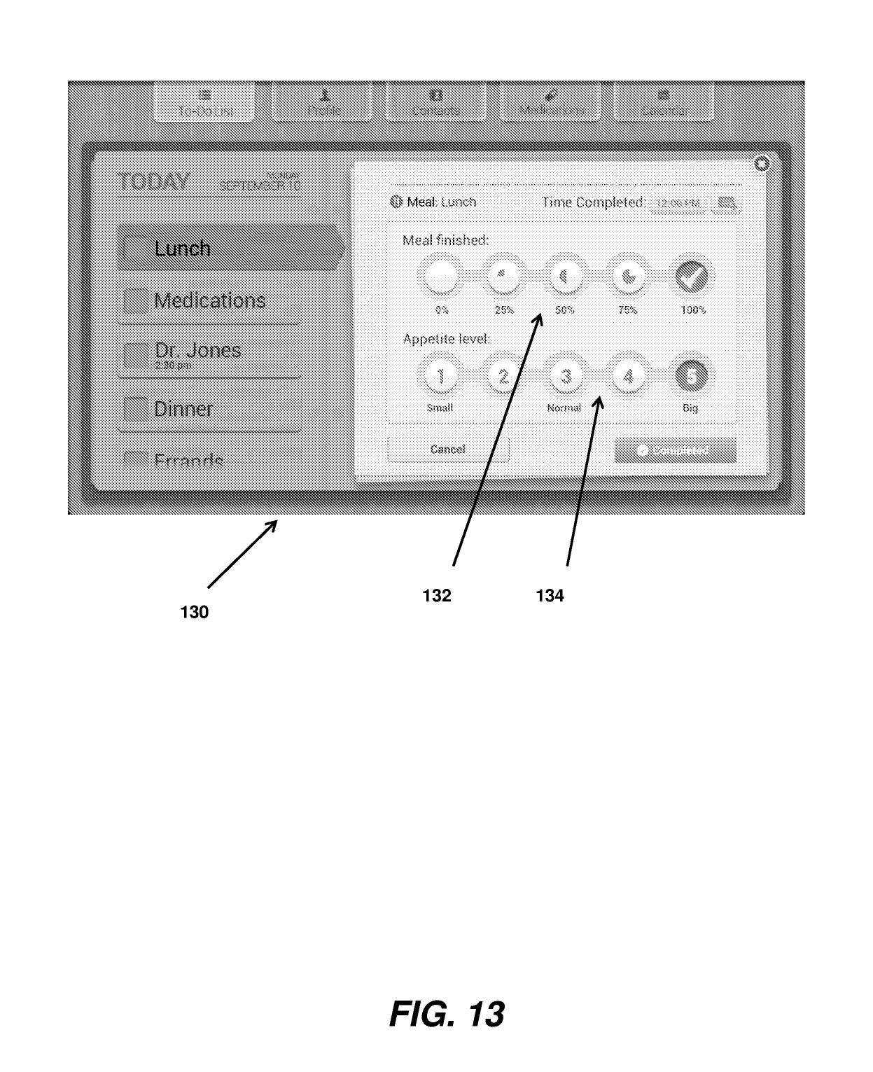

The problem of planning meals is solved by a meal planning and tracking function which allows a caregiver to select meal plans based on a client's dietary and medical needs. Such a meal planning function may list possible meal selections based on patient dietary and medical information previously entered. The meal planning and tracking function may allow a caregiver to enter a client's actual consumption information and also store food allergies and client preferences. Using such dietary, allergy, and preference information, the choices available to plan meals may be customized to allow a caregiver to quickly plan a meal schedule by choosing from a list of available options. During the selection process, the application may track meals provided to a client, process this information, and provide feedback and suggestions to a caregiver such that the resulting meal plan satisfies dietary and medical requirements. When using such an application, a caregiver may be presented with meal choices that satisfy the requirements described above. Referring to FIG. 12, the application may display food preferences and allergies 120. The in-home care application may present a caregiver or family member an interface 130 which allows entry of a client's consumption of a meal 132 and appetite level 134 as illustrated in FIG. 13.

Grocery List

When meal choices have been selected using a meal planning and tracking or other input function, a list of required ingredients may be generated. This list may be stored and made available to client and the client's family. The client and client's family members may make adjustments to the list in order to create a grocery list specific to the client. In this way, a grocery list may be created that automatically takes into account the meal choices selected by caregivers to satisfy the medical and dietary requirements of a client. This list may be modified to indicate which items are still required as the items listed are purchased. This feature may allow items to be provided by caregivers, family members, and other parties.

Medication Tracking (RX Refill Notification, Daily Consumption Confirmation, Dosage, Notification of Missed Pills, Safety)

A client may require additional levels of care including additional medications as they age. As the number of medications and associated dosages scheduled increases, administration of these drugs and other supplements can be difficult to manage. A medication tracking function implemented in an in-home care application may track aspects of a client's medication such as refill information, medication reminders, consumption confirmation, dosage information, and medication lists. Information related to a client's prescriptions may be entered into such an application, and in real-time, assess the drugs for any potential adverse interactions. When a client receives and consumes a dosage of medication, that information is entered into the in-home care application. The consumption information may be used to trigger reminders for clients and care providers to help insure the client is consuming the drug as prescribed.

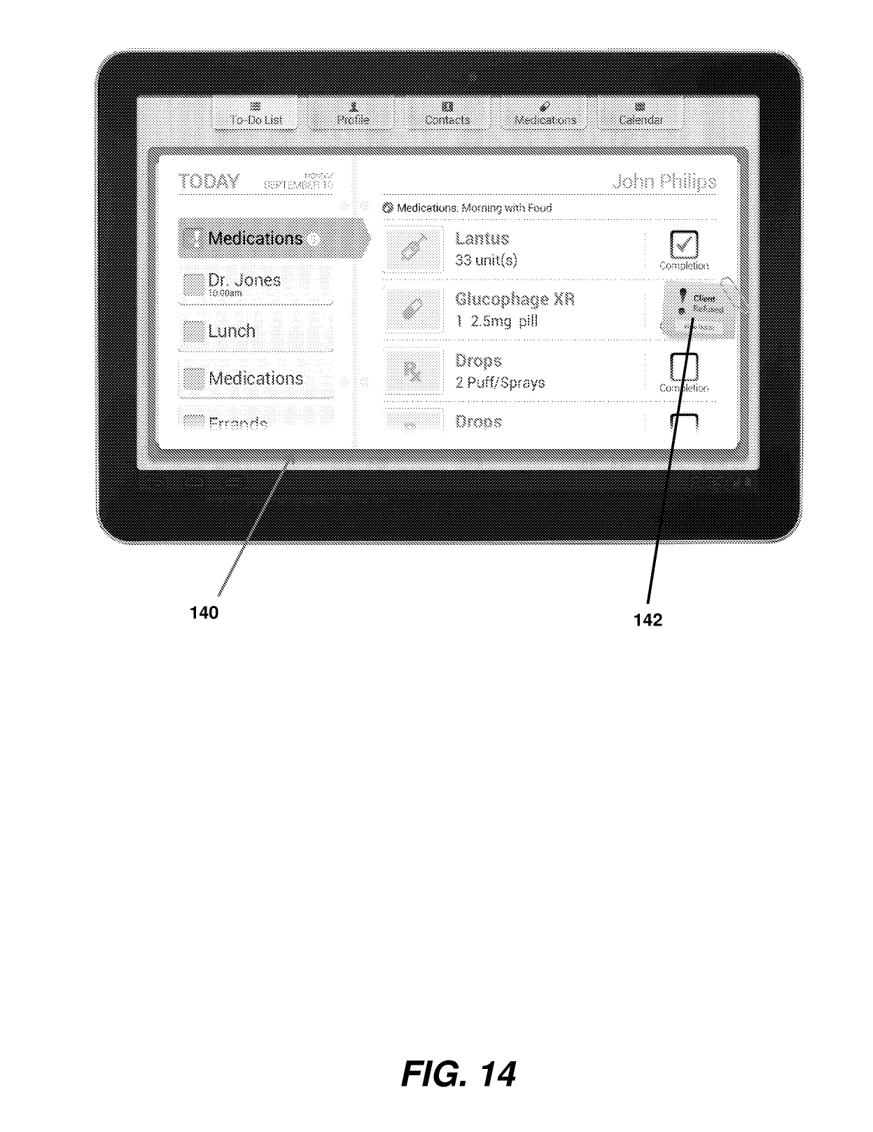

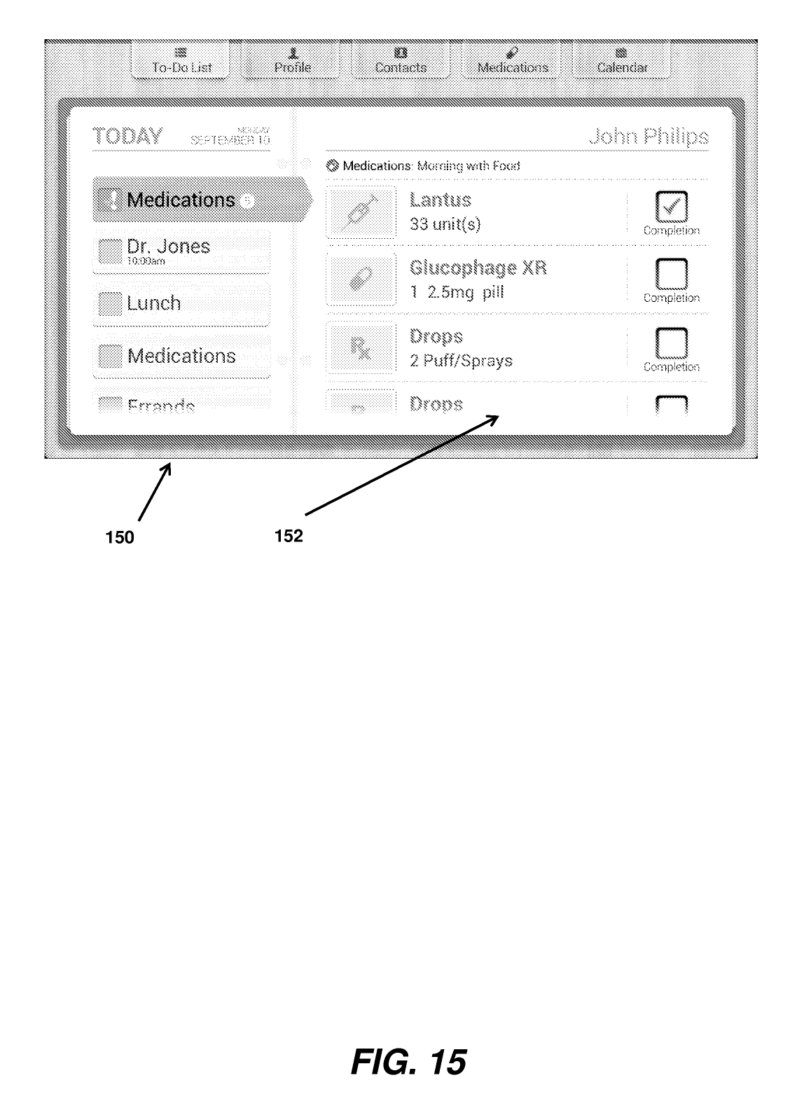

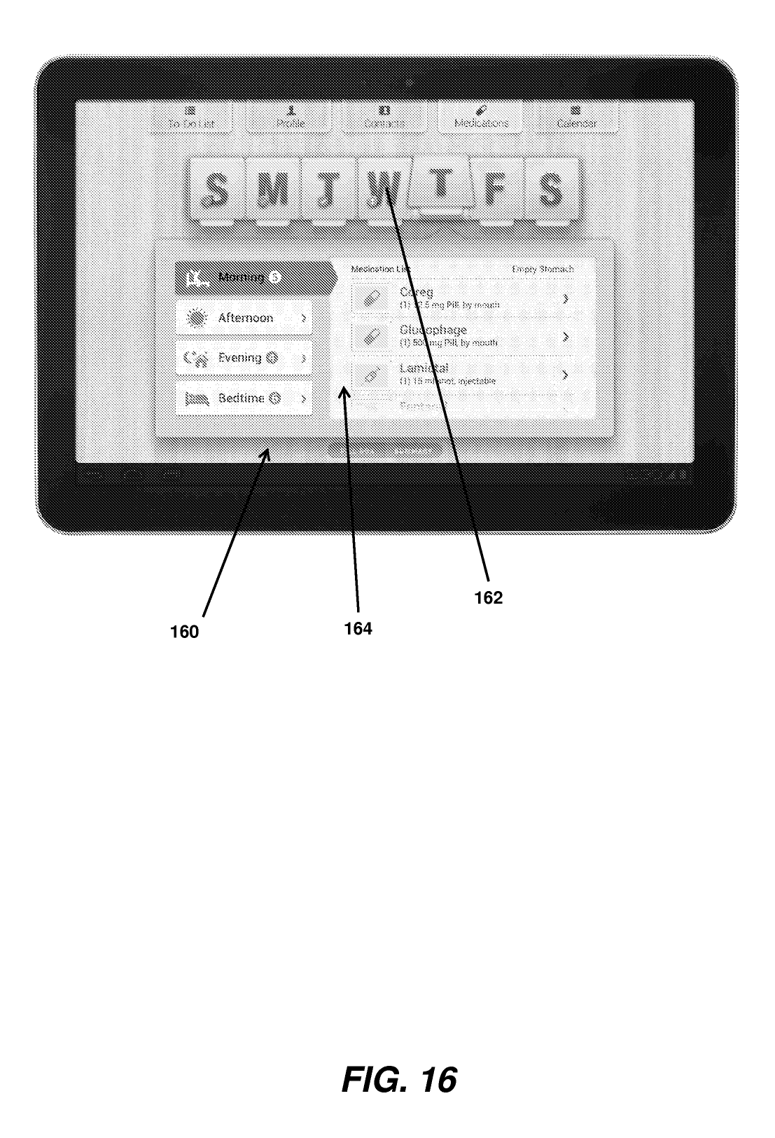

Referring to FIG. 14, which illustrates a daily to-do list user interface 140 displayed on a tablet computing device, changes in medication may be used by the in-home care application to trigger an alert 142 to caregivers. In addition to a user interface 140, such alerts may be delivered using instant messaging and may provide listings of potential side effects. These alerts may allow a caregiver to anticipate changes in health or behavior of a client such that they may react appropriately to such changes in order to prevent harm to the client. Referring to FIG. 15, reminders 152 may be displayed in a user interface 150 in a to-do list format. Other means of displaying drug consumption information and reminders may be a virtual pill case 162 as illustrated in the user interface 160 shown in FIG. 16. A user of the in-home care application may obtain more information about a drug by selecting a drug displayed in a drug dosage list 164 by selecting the listing for that drug, and search for any potential drug interactions and check dosage safety.

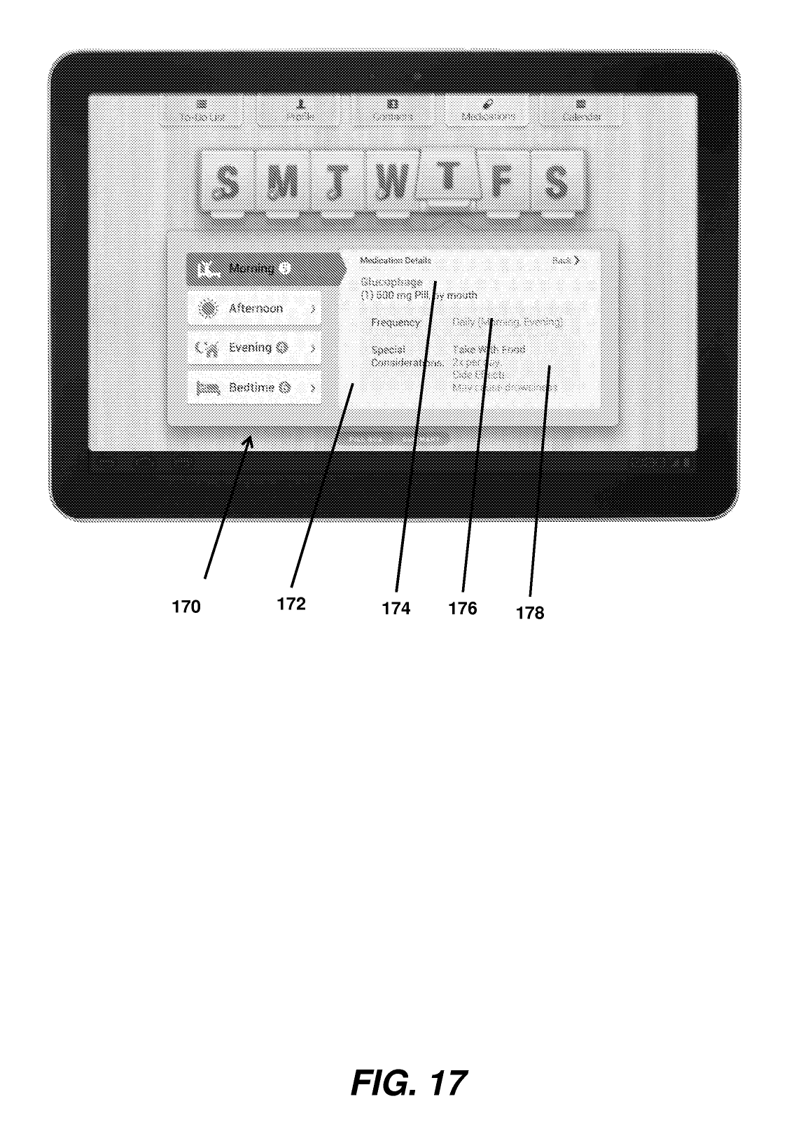

Referring to FIG. 17, when selected, an information window 172 may open in a user interface 170 which contains additional information about a drug. Such additional information may include dosage 174, frequency 176, safety, and special considerations and side effects 178. Information pertaining to drug consumption may be used to monitor the expected remaining medication for a current dispensation. When the calculated amount of drug remaining falls below a preset limit, a notification may be provided to users of the in-home care application so that a refill can be ordered before a client runs out of the drug.

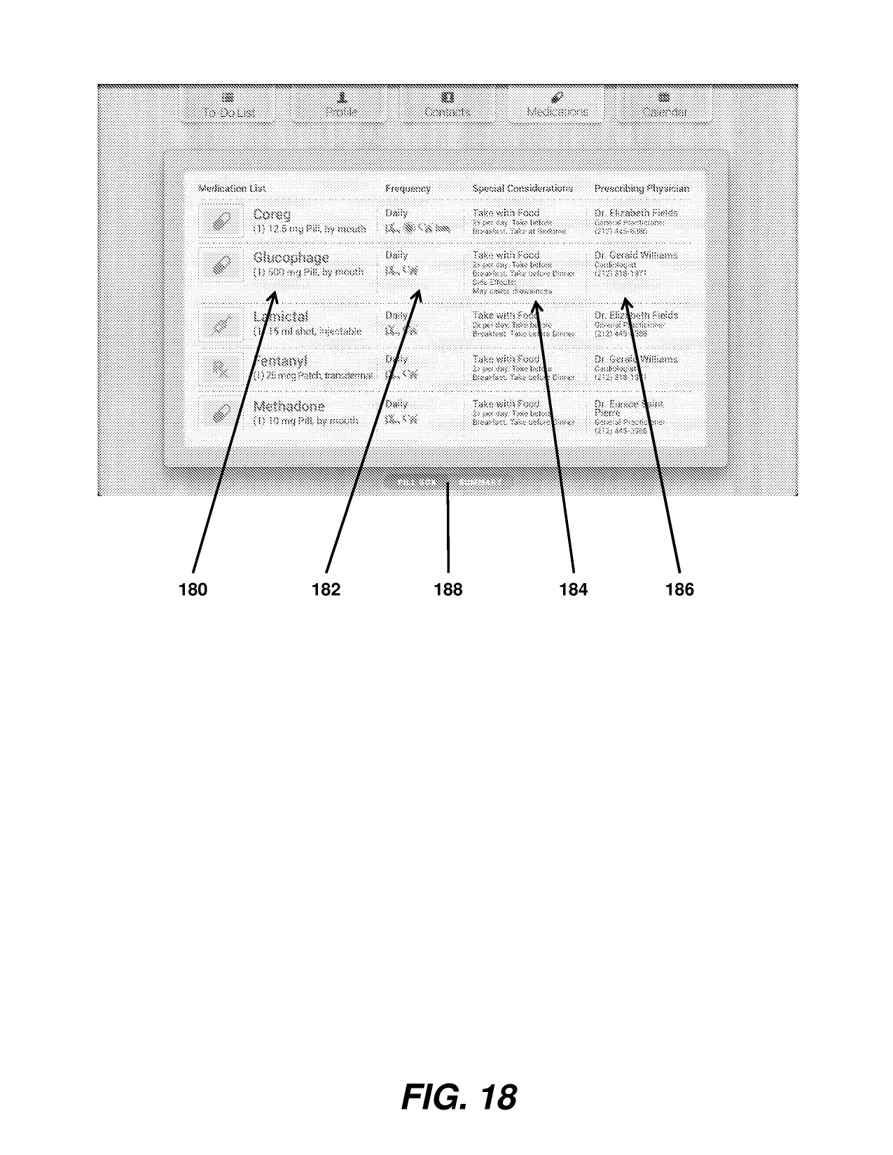

In addition to a to-do list and virtual pill case format, a summary of drugs prescribed for a client may be displayed in a user interface to provide an overview of a client's drug requirements to a caregiver or other user of the in-home care application. Additional information may be included on such an interface such as administration instructions, method of delivery and dosage, dosage times, and a physician contact related to each drug. Referring to FIG. 18, a representative embodiment of such a summary of drug requirements user interface may comprise: a medication list with dosage information 180; frequency of administration 182 which may include icons to designate common administration times; special considerations or administration instructions 184; and information pertaining to the prescribing physician 186. A possible embodiment of a medication tracking interface may include a control 188 to select between a summary and a virtual pillbox interface.

Companion Scheduling

The problem of ensuring that a client has a sufficient number of visits from care providers, family, friends and other visitors is solved by companion scheduling function. Such a function may use a calendar implemented in the in-home care application. Caregivers may enter information related to visitors comprising time and duration of visit into such a calendar in order to track or schedule a client's time such that the client has a sufficient number of visitors and interactions with care providers during a period of time. Visitor information may be reviewed by caregivers, family members, in-home care provider administrators, and other parties which may need access to the record of a client's visitors. The in-home care application may track a client's visit information and process that information such that alerts may be generated at predetermined levels if the number of visitors is too few or too many. Such an alert may allow caregivers and family members to schedule a greater or lesser number of visits to a client.

Video Chat

An in-home health care application may implement a video chat function to allow caregivers, clients, family members, and other users of the application to communicate face-to-face even when located remotely from one another. A user of the system may initiate such a function by selecting the video chat function from a menu within the in-home care application. A video camera connected to the computer device in a client's home may be configured by the application to provide real-time video and/or audio communication between the computer device and another computer device through the in-home care application portal.

As previously described, the in-home care application may be enabled on a computing device in a client's home which communicates with an application portal at an in-home care provider. Because this communication link exists, it may be subject to continuous monitoring such that an alert function may be implemented. An implementation of an alert function may allow a client to send a message to the in-home care provider in the event of an emergency. This message may cause an alert to be dispatched to emergency personnel so that help can be directed to a client as quickly as possible. This alert may be used to trigger other monitoring functionality such as a microphone or video camera contained in the computing device to provide additional information to emergency responders.

Wireless Monitoring (Air Quality, Blood Pressure, Room Temperature, Hydration, Motion Sensors, Glucose)

Gathering test results and other date from a client's home may require a caregiver to enter such information into various logs which then must be gathered and consolidated for reporting. The in-home care application may be configured to communicate with wireless monitoring equipment such that information is automatically gathered and communicated to the in-home care application portal. The in-home care application may analyze this information and provide the analysis to caregivers so that they can respond appropriately should action be required. Examples of wireless monitoring devices comprise air quality, room temperature, smoke detection, client motion, weight, blood pressure, hydration, and glucose levels. Information may be tracked by a family member or care provider in real-time, via a dashboard on a web portal. Automatic alerts may be configured to provide alerts should a monitored parameter exceed predetermined parameters.

Assessment Tool

An in-home care application may used to create an in-depth assessment of a client's condition and needs. By monitoring and analyzing the information entered into the application by caregivers, family members, and the client, the application may be used to generate assessment reports specific to a client. Such information may be used as a basis for a client's care plan. Such a plan may include recommended changes to a client's care management plan which may include more caregiver time or additional monitoring functionality to be deployed to the in-home care application. The assessment data may also be used to provide personal health reports to other parties responsible for providing care to a patient that may not have access to the in-home care application directly.

General Health Tracker

The problem of tracking a client's general health and reporting such information is solved by a general health tracker function implemented in the in-home care application. During visits with a client to provide care, a caregiver may rate the client's overall health and enter this information using the in-home care application. The application may gather this information and present it in the form of a graph, chart, or other method that illustrates a client's general condition over time. A similar report may be created that displays a client's mood. A caregiver may be prompted to enter a client's mood on a daily or other basis. Mood may be selected from a list of descriptors related to a client's health. When a family member, caregiver, or other party wishes to monitor a client's general mood, that party may view tracker information which provides a graphical representation of a client's health or mood over a period of time which may be specified by the viewer of the report.

Dashboard Landing Page

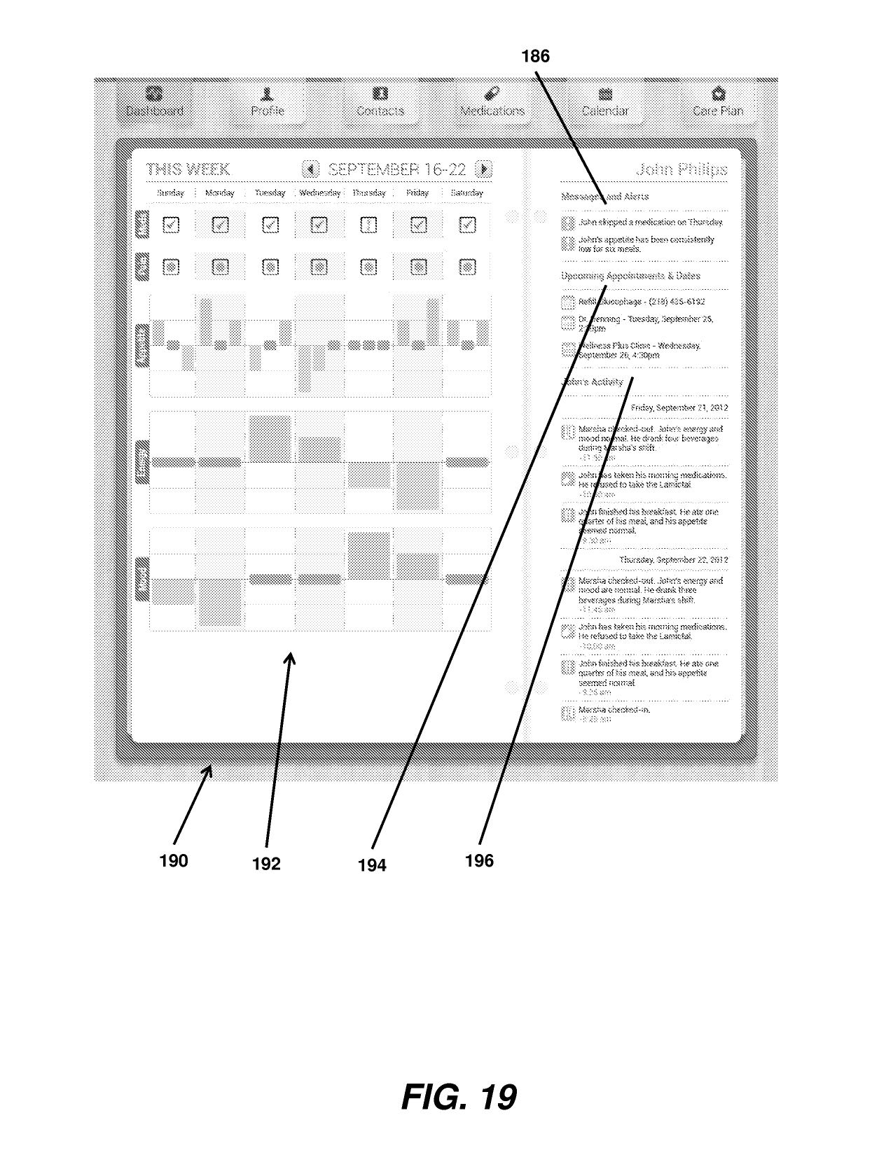

The problem of communicating a client's health status and trends to family members and caregivers is solved by a dashboard landing page function contained within the application portal of the in-home care application. As illustrated in FIG. 19, such a landing page may be presented in a user interface 190 in order to provide a single location from which general information about a client's health and activities may be viewed. Such a landing page may comprise calendar information 192 to allow a viewer to see upcoming appointments 194, a display of messages and alerts 196, and an activity section 198 that contains information about caregiver visits to a client, recommended follow-up actions, a client's appetite and meals, and general health and mood information reported by caregivers. Such a landing page may also contain links to allow family members to contact the in-home care provider with questions or concerns.

While certain embodiments of the disclosed in-home care application are described in detail above, the scope of the invention is not to be considered limited by such disclosure, and modifications are possible without departing from the spirit of the invention as evidenced by the claims. One skilled in the art would recognize that such modifications are possible without departing from the scope of the claimed invention.

1. A computerized method for scheduling tasks for an in-home caregiver comprising:
(a) receiving at a server task data for a plurality of tasks required to provide care for a client, said task data comprising for each task:
(1) a task description; and
(2) a task location;
(b) identifying in said plurality of tasks a first task comprising in addition to a first task description and a first task location:
(1) a first task date; and
(2) a first task time;
(c) applying at said server task grouping rules said plurality of tasks to identify a second task comprising a second task location within a specified proximity of:
(1) said first task location; and
(2) a client's in-home location;
(d) generating by said server a client care schedule comprising for said first task date:
(1) in a first time slot for said first task, said first task description, said first task location, and said first task time; and
(2) in a second time slot adjacent to said first time slot for said second task, said second task description and said second task location; and
(e) synchronizing said client schedule with an electronic calendar on a mobile computing device comprising:
(1) a communication link to an application portal for receiving said client schedule from said server; and
(2) an in-home care application for modifying said electronic calendar according to said client schedule.

2. The computerized method of claim 1 wherein said task data comprises task data selected from the group consisting of an appointment, an errand, a leisure activity, a meal, and a prescription administration.

3. The computerized method of claim 1 wherein task location is selected from the group consisting of an in-home location and an out-of-home location.

4. The computerized method of claim 1 wherein generating by said server a client schedule comprises rescheduling a third task assigned to said first task date.

5. The computerized method of claim 1 wherein said first task is an appointment and said second task is an errand.

6. The computerized method of claim 1 further comprising tracking at said server completion of said first task and said second task by said caregiver.

7. The computerized method of claim 6 wherein said task data further comprises a time period for completing said task.

8. The computerized method of claim 7 further comprising transmitting an alert to said caregiver if said first task or said second task is not completed within said time period.

9. A computerized method for scheduling tasks for a caregiver comprising:
(a) receiving at a server task data for a plurality of tasks, said tasks required to provide care for a client;
(b) applying by said server to said task data task grouping rules to organize said plurality of tasks into a plurality of groups comprising:
(1) a first group of in-home tasks; and
(2) a second group of out-of-home tasks;
(c) generating by said server a client care schedule for said comprising:
(1) for a first task date, said first group of in-home tasks; and
(2) for a second task date, said second group of out-of-home tasks; and
(d) synchronizing said client schedule with an electronic calendar on a mobile computing device comprising:
(1) a communication link to an application portal for receiving said client schedule from said server; and
(2) an in-home care application for modifying said electronic calendar according to said client schedule.

10. The computerized method of claim 9 wherein said task data comprises task data selected from the group consisting of an appointment, an errand, a leisure activity, a meal, and a prescription administration.

11. The computerized method of claim 9 wherein organizing at said server said task data into a plurality of groups comprises organizing said tasks according to task location.

12. The computerized method of claim 9 wherein generating by said server a client schedule comprises rescheduling an out-of-home task originally scheduled for said first task date.

13. The computerized method of claim 9 wherein generating by said server a client schedule comprises rescheduling an in-home task originally scheduled for said second task date.

14. The computerized method of claim 9 wherein said task data further comprises a time period for completing said task.

15. The computerized method of claim 9 further comprising tracking at said server completion of said in-home tasks and said out-of-home tasks.

16. The computerized method of claim 15 wherein said task data further comprises a time period for completing said task.

17. The computerized method of claim 16 further comprising transmitting an alert to said caregiver if said task is not completed within said time period.

18. A computerized task scheduling system for an in-home caregiver comprising:
(1) a server executing instructions to:
(a) receive at a server task data for a plurality of tasks required to provide care for a client, said task data comprising for each task:
(i) a task description; and
(ii) a task location;
(b) applying by said server task grouping rules to said tasks to organize said tasks into at least two groups according to said task location and the client's in-home location;
(c) generate by said server a client schedule comprising:
(i) for a first task date, a first group of tasks assigned to said first task date according to a first task location; and
(ii) for a second task date, a second group of tasks assigned to said a second task date according to a second task location; and
(d) transmit said client schedule to said caregiver; and
(2) a mobile computing device executing instructions of an in-home application installed on said mobile computing device to:
(a) receive at said mobile computing device from an application portal at said server said client schedule;
(b) synchronize said client schedule with an electronic calendar on said mobile computing device; and
(c) receive at said mobile computing device from said caregiver completion data for tasks on said electronic calendar.

19. The computerized system of claim 18 wherein said first group of tasks comprises in-home tasks and said second group of tasks comprising out-of-home tasks.

20. The computerized system of claim 18 wherein said server further executes instructions to reschedule tasks originally scheduled for said first task date and said second task date.
